(19) United States
(12) Patent Application Publication
(10) Pub. No.: US 2025/0189553 A1
(43) Pub. Date: Jun. 12, 2025

(54) WHEEL SPEED AND ACCELERATION SENSING DEVICE AND METHOD OF MANUFACTURING THE SAME

(71) Applicant: HL Mando Corporation, Pyeongtaek-si (KR)

(72) Inventor: YongKyun JUNG, Pyeongtaek-si (KR)

(21) Appl. No.: 18/935,120

(22) Filed: Nov. 1, 2024

(30) Foreign Application Priority Data
Dec. 12, 2023 (KR) 10-2023-0179867

(51) Int. Cl. G01P 1/02; G01P 3/44

(52) U.S. Cl. CPC G01P 1/026; G01P 3/44

(57) ABSTRACT

Disclosed are a wheel speed and acceleration sensing device and a method of manufacturing the same. A wheel speed and acceleration sensing device according to one aspect of the present disclosure, which is disposed in a vehicle and detects a wheel speed and a vertical acceleration of the vehicle, may include a housing, a wheel speed sensor which is disposed in the housing and detects the wheel speed of the vehicle, and an acceleration sensor which is disposed in the housing and detects the vertical acceleration of the vehicle.

### CROSS-REFERENCE TO RELATED APPLICATION

This application claims priority to and the benefit of Korean Patent Application No. 10-2023-0179867, filed on Dec. 12, 2023, the disclosures of which are incorporated herein by reference in its entirety.

### BACKGROUND

### 1. Technical Field

The present disclosure relates to a wheel speed and acceleration sensing device and a method of manufacturing the same, and more specifically, to a wheel speed and acceleration sensing device mounted at a wheel of a vehicle to measure a wheel speed of the vehicle and a vertical acceleration of a suspension, and a method of manufacturing the same.

### 2. Related Art

Various devices may be installed in vehicles for improving traveling and braking stability. For example, an integrated dynamic brake (IDB), in which an electronics controlled suspension (ECS) for improving stability and ride quality while traveling, an electric booster for generating a hydraulic pressure by driving a piston through a motor, and a vehicle body control device are integrated, and the like may be mounted in a vehicle.

In order to control such devices, signals are received from sensors such as a wheel speed sensor and an acceleration sensor. The wheel speed sensor may be mounted on a knuckle structure of a vehicle and may transmit speed information to an ESC or IDB system. In addition, the acceleration sensor may be mounted on a suspension of the vehicle, measure a vertical acceleration value of the suspension, and transmit the vertical acceleration value to a suspension ESC system.

### SUMMARY

The present invention is directed to providing a wheel speed and acceleration sensing device which allows a wheel speed sensor and an acceleration sensor to be integrally mounted so as to simplify a layout of a vehicle, and a method of manufacturing the same.

The present disclosure is also directed to providing a wheel speed and acceleration sensing device in which a wheel speed sensor and an acceleration sensor are stably and fixedly disposed in one housing and effectively protected from an external environment, and a method of manufacturing the same.

The objects of the present disclosure are not limited to the above-described objects, and other objects that are not mentioned will be able to be clearly understood by those skilled in the art to which the present disclosure pertains from the following description.

In accordance with one aspect of the present invention, there is provided a wheel speed and acceleration sensing device which is disposed in a vehicle and detects a wheel speed and a vertical acceleration of the vehicle, the wheel speed and acceleration sensing device including a housing, a wheel speed sensor which is disposed in the housing and detects the wheel speed of the vehicle, and an acceleration sensor which is disposed in the housing and detects the vertical acceleration of the vehicle.

In this case, the wheel speed and acceleration sensing device may further include a plurality of wheel speed sensor cables each having one end portion connected to the wheel speed sensor in the housing and the other end portion extending outward from the housing, a plurality of acceleration sensor cables each having one end portion connected to the acceleration sensor in the housing and the other end portion extending outward from the housing, and an integrated sheath which covers the plurality of the wheel speed sensor cables and the plurality of the acceleration sensor cables extending outward from the housing in one bundle.

In addition, the integrated wire may further include a connector connected to the other end portion of each of the plurality of the wheel speed sensor cables and the plurality of the acceleration sensor cables such that the plurality of the wheel speed sensor cables and the plurality of the acceleration sensor cables are connected to an outside.

In addition, the wheel speed and acceleration sensing device may further include a holder disposed in the housing and including a first sensor seating part in which the wheel speed sensor is disposed and a second sensor seating part in which the acceleration sensor is disposed.

In addition, the holder may further include a cable seating part which extends toward one side of the first sensor seating part and in which the plurality of wheel speed sensor cables or the plurality of acceleration sensor cables electrically connected to the wheel speed sensor or the acceleration sensor are disposed.

In addition, the second sensor seating part of the holder may be connected to a side portion of the cable seating part.

In addition, the first sensor seating part may include a first sensor seating plate supporting a lower surface of the wheel speed sensor and a first sidewall protruding upward from the first sensor seating plate and surrounding at least a portion of a side surface of the wheel speed sensor.

In addition, the second sensor seating part may include a second sensor seating plate supporting a lower surface of the acceleration sensor and a second sidewall protruding upward from the second sensor seating plate and surrounding at least a portion of a side surface of the acceleration sensor.

In addition, the wheel speed and acceleration sensing device may further include a filling member disposed to fill a space between the second sensor seating part and the acceleration sensor to fix the acceleration sensor to the second sensor seating part.

In addition, the filling member may be formed of a resin material.

In addition, the second sensor seating part may further include first guide walls which protrude upward from the second sensor seating plate to be spaced a predetermined interval from each other at a portion, at which the plurality of acceleration sensor cables electrically connected to the acceleration sensor enter the acceleration sensor, and form a plurality of entry paths which guide the plurality of acceleration sensor cables to enter in one direction.

In addition, the second sensor seating part may further include second guide walls which protrude upward from the second sensor seating plate to be spaced a predetermined interval from each other at a portion spaced apart from the first guide walls in one direction to extend the plurality of entry paths.

In addition, the wheel speed and acceleration sensing device may further include a filling guide member which defines a boundary of one side of the filling member and disposed between the first guide walls and the second guide walls.

In addition, the filling guide member may include a guide body supporting the filling member and preventing diffusion of the filling member and a plurality of grooves recessed upward from a lower corner of the guide body to be spaced a predetermined interval from each other such that the plurality of acceleration sensor cables disposed in the plurality of the entry paths are inserted.

In addition, the housing may be disposed to seal the holder, the wheel speed sensor, the acceleration sensor, and the filling member from an outside.

In accordance with another aspect of the present invention, there is provided a method of manufacturing a wheel speed and acceleration sensing device including arranging a holder including a first sensor seating part and a second sensor seating part, arranging a wheel speed sensor in the first sensor seating part and arranging an acceleration sensor in the second sensor seating part, connecting a plurality of cables to each of the wheel speed sensor and the acceleration sensor, and forming a housing which covers the holder, the wheel speed sensor, and the acceleration sensor.

In this case, the holder may be formed by performing integrally injection molding on the first sensor seating part and the second sensor seating part.

In addition, the method of manufacturing a wheel speed and acceleration sensing device may further include filling, with a filling member, a space between the second sensor seating part and the acceleration sensor to fix the acceleration sensor to the second sensor seating part between the connecting of the plurality of cables and the forming of the housing.

In addition, the method of manufacturing a wheel speed and acceleration sensing device may further include arranging a filling guide member which defines a boundary of one side of the filling member in the second sensor seating part before the filling with the filling member.

In addition, the housing may be injection-molded in the forming of the housing.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view illustrating a configuration of a wheel speed and acceleration sensing device according to one embodiment of the present disclosure;

FIG. 2 is a perspective view illustrating the wheel speed and acceleration sensing device according to one embodiment of the present disclosure;

FIG. 3 is an exploded perspective view illustrating the wheel speed and acceleration sensing device according to one embodiment of the present disclosure;

FIG. 4 is a view illustrating a holder of the wheel speed and acceleration sensing device according to one embodiment of the present disclosure;

FIG. 5 is a view illustrating a state in which a wheel speed sensor and an acceleration sensor are disposed in the holder of the wheel speed and acceleration sensing device according to one embodiment of the present disclosure;

FIG. 6 is a view illustrating a state in which the wheel speed sensor and the acceleration sensor are disposed in the holder of the wheel speed and acceleration sensing device and cables are connected to the wheel speed sensor and the acceleration sensor according to one embodiment of the present disclosure;

FIG. 7 is a view illustrating a state in which the wheel speed sensor and the acceleration sensor are disposed in the holder of the wheel speed and acceleration sensing device, the cables are connected to the wheel speed sensor and the acceleration sensor, and a second sensor seating part is filled with a filling member according to one embodiment of the present disclosure;

FIG. 8 is a cross-sectional view illustrating the second sensor seating part in one direction in the state in which the wheel speed sensor and the acceleration sensor are disposed in the holder of the wheel speed and acceleration sensing device, the cables are connected to the wheel speed sensor and the acceleration sensor, and the second sensor seating part is filled with the filling member according to one embodiment of the present disclosure; and

FIG. 9 is a flowchart illustrating a method of manufacturing a wheel speed and acceleration sensing device according to one embodiment of the present disclosure.

### DETAILED DESCRIPTION OF EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

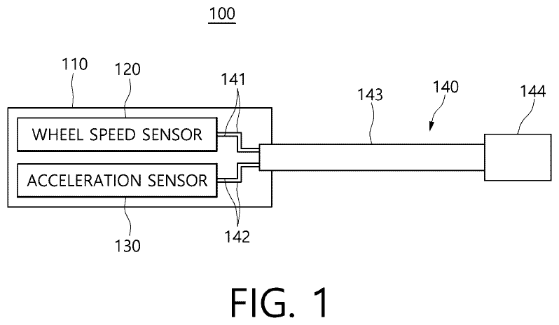

FIG. 1 is a schematic view illustrating a configuration of a wheel speed and acceleration sensing device according to one embodiment of the present disclosure. In FIG. 1, a schematic block diagram of the configuration of the wheel speed and acceleration sensing device according to one embodiment of the present disclosure is illustrated, and some components are omitted.

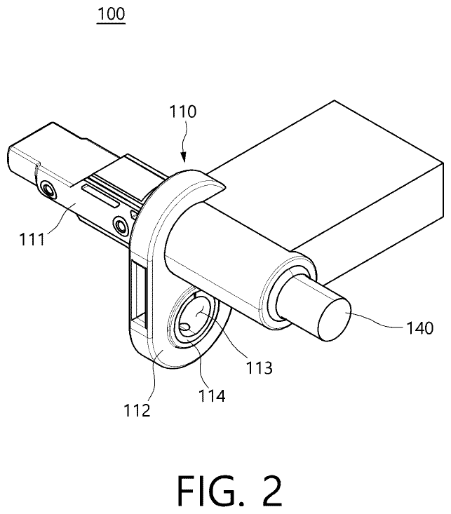

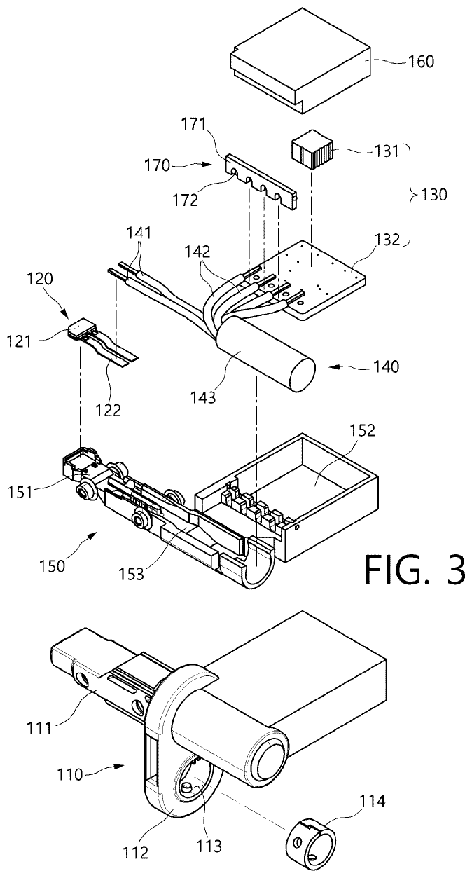

FIG. 2 is a perspective view illustrating the wheel speed and acceleration sensing device according to one embodiment of the present disclosure, and FIG. 3 is an exploded perspective view illustrating the wheel speed and acceleration sensing device according to one embodiment of the present disclosure. In FIGS. 2 and 3, only one end portion of an integrated wire 140 is illustrated.

A wheel speed and acceleration sensing device 100 according to one embodiment of the present disclosure provides a structure in which a wheel speed sensor 120 and an acceleration sensor 130 are integrally disposed in one housing 110. The wheel speed and acceleration sensing device 100 according to one embodiment of the present disclosure allows the wheel speed sensor 120 and the acceleration sensor 130 to be integrally installed at once without being individually installed, thereby simplifying a layout of a vehicle and improving assemblability of the vehicle.

The wheel speed and acceleration sensing device 100 according to one embodiment of the present disclosure is disposed in the vehicle and detects a wheel speed and a wheel acceleration of the vehicle. Referring to FIGS. 1 to 3, the wheel speed and acceleration sensing device 100 according to one embodiment of the present disclosure may include the housing 110, the wheel speed sensor 120, the acceleration sensor 130, the integrated wire 140, a holder 150, a filling member 160, and a filling guide member 170.

The housing 110 accommodates the wheel speed sensor 120 and the acceleration sensor 130. More specifically, the housing 110 may accommodate the wheel speed sensor 120 and the acceleration sensor 130 while sealing the wheel speed sensor 120 and the acceleration sensor 130 from the outside.

For example, the housing 110 may be formed of a resin material. In addition, the housing 110 may be formed through injection molding.

In one embodiment of the present disclosure, in a state in which the wheel speed sensor 120, the acceleration sensor 130, and the integrated wire 140 are disposed in the holder 150 and the filling member 160 is disposed to fill a space between the holder 150 and the acceleration sensor 130, the wheel speed sensor 120, the acceleration sensor 130, the holder 150, and the filling member 160 may be disposed in the housing 110 and sealed from the outside. In this case, the housing 110 may also accommodate one end portion of the integrated wire 140.

In addition, the housing 110 may include a housing body 111, in which the wheel speed sensor 120, the acceleration sensor 130, the holder 150, and the filling member 160 are disposed, and a housing fastening part 112 which is connected to the housing body 111 such that a fastening member (not shown) for fastening the housing 110 to a vehicle body is coupled to the housing fastening part 112.

In one embodiment of the present disclosure, the housing body 111 may have an “L” shape. In addition, the wheel speed sensor 120 or the acceleration sensor 130 may be disposed in each end portion of the housing body 111 having the “L” shape.

In addition, the housing fastening part 112 may extend in a direction perpendicular to the housing body 111 and include a through hole 113. For example, the housing fastening part 112 may have a plate shape perpendicularly intersecting the housing body 111.

The fastening member (not shown) which fastens the housing 110 to the vehicle body may be coupled through the through hole 113 of the housing fastening part 112. Meanwhile, a bushing 114 may be disposed at the through hole 113 to improve fastening of the fastening member.

The wheel speed sensor 120 detects a wheel speed of the vehicle. The wheel speed sensor 120 may detect a tone wheel or encoder rotating with a wheel of the vehicle.

The wheel speed sensor 120 is disposed in the housing 110. More specifically, the wheel speed sensor 120 may be disposed in a first sensor seating part 151 of the holder 150 which will be described below.

The wheel speed sensor 120 may be formed of an integrated circuit (IC) chip. For example, the wheel speed sensor 120 may include a wheel speed sensor body 121 in which a sensing element is disposed and a plurality of lead frames 122 for connecting the wheel speed sensor body 121 to an external power source or transmitting or receiving signals.

In this case, any one of the plurality of lead frames 122 may be for connecting the power source to the sensor body 121. In addition, the others of the plurality of lead frames 122 may be for transmitting or receiving signals.

The acceleration sensor 130 detects a vertical acceleration of the vehicle. More specifically, the acceleration sensor 130 may detect the vertical acceleration occurring when a knuckle or suspension of the vehicle moves vertically.

The acceleration sensor 130 is disposed in the housing 110. More specifically, the acceleration sensor 130 may be disposed in a second sensor seating part 152 of the holder 150 which will be described below.

The acceleration sensor 130 may include an acceleration sensing element 131 and a circuit board 132 on which the acceleration sensing element 131 is disposed. For example, the acceleration sensor 130 may be a wheel gravity (G) sensor. In this case, the acceleration sensing element 131 may be formed as an IC.

The circuit board 132 of the acceleration sensor 130 may include a power pin and a plurality of pins for transmitting or receiving signals. For example, the circuit board 132 may include a pin for power supply and three pins for transmitting or receiving analog signals. In addition, the circuit board 132 may also include a power pin and two pins for transmitting or receiving digital signals.

The integrated wire 140 connects the wheel speed sensor 120 or the acceleration sensor 130 to the external power source and transmits sensing information of the wheel speed sensor 120 or the acceleration sensor 130 to the outside. The integrated wire 140 may include a wheel speed sensor cable 141, an acceleration sensor cable 142, an integrated sheath 143, and a connector 144.

One end portion of the wheel speed sensor cable 141 may be connected to the wheel speed sensor 120 in the housing 110, and the other end portion extends outward from the housing 110. The wheel speed sensor cable 141 may be provided as a plurality of wheel speed sensor cables 141.

For example, two wheel speed sensor cables 141 may be disposed. In this case, one of two wheel speed sensor cables 141 may be for connecting the power source, and the other may be for transmitting or receiving a signal.

One end portion of the acceleration sensor cable 142 is connected to the acceleration sensor 130 in the housing 110, and the other end portion extends outward from the housing 110. The acceleration sensor cable 142 may be disposed as a plurality of acceleration sensor cables 142.

For example, four acceleration sensor cables 142 may be disposed. In this case, the acceleration sensors 130 may transmit a signal in an analog type, one of four acceleration sensor cable 142 is for the power source, and the remaining three thereof may be for transmitting the signal.

As another example, three acceleration sensor cables 142 may be disposed. In this case, the acceleration sensors 130 may transmit a signal in a digital type, one of three acceleration sensor cables 142 may be for the power source, and the remaining two may be for transmitting the signal.

The integrated sheath 143 covers the plurality of wheel speed sensor cables 141 and the plurality of acceleration sensor cables 142 extending outward from the housing 110 in one bundle. The integrated sheath 143 binds the plurality of wheel speed sensor cables 141 and the plurality of acceleration sensor cables 142 extending outward from the housing 110 into one and allows wiring to be efficiently performed.

In one embodiment of the present disclosure, one end of the integrated sheath 143 may be disposed in the housing 110. In addition, the plurality of wheel speed sensor cables 141 and the plurality of acceleration sensor cables 142 may extend from one end portion of the integrated sheath 143 disposed in the housing 110 to the outside of the integrated sheath 143 and may be connected to the wheel speed sensor 120 or the acceleration sensor 130.

The connector 144 is connected to the other end portions of the plurality of wheel speed sensor cables 141 and the plurality of acceleration sensor cables 142 such that the plurality of wheel speed sensor cables 141 and the plurality of acceleration sensor cables 142 are connected to the outside. For example, the connector 144 may be provided to be branched off into a portion connected to the plurality of wheel speed sensor cables 141 and a portion connected to the plurality of acceleration sensor cables 142.

The holder 150 is provided such that the wheel speed sensor 120 and the acceleration sensor 130 are disposed therein. The holder 150 may be disposed in the housing 110 in a state in which the wheel speed sensor 120 and the acceleration sensor 130 are disposed in the holder 150.

The holder 150 fixes the wheel speed sensor 120 and the acceleration sensor 130 such that the wheel speed sensor 120 and the acceleration sensor 130 are stably disposed in the housing 110. In other words, the holder 150 allows the wheel speed sensor 120 and the acceleration sensor 130 to be stably fixed at set locations in the housing 110.

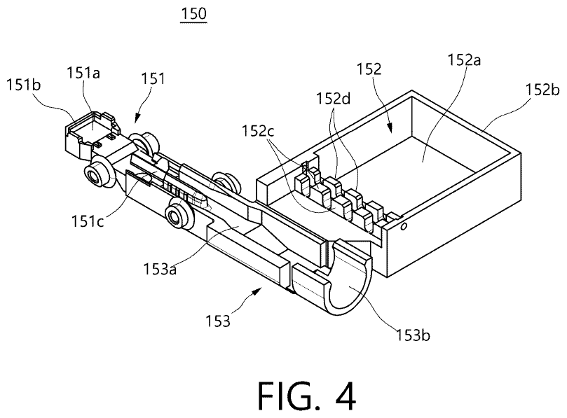

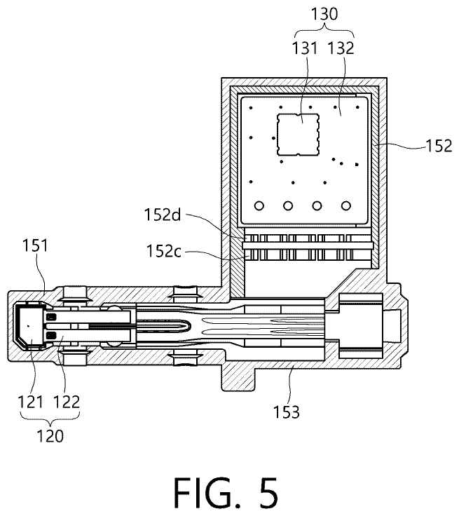

FIG. 4 is a view illustrating the holder of the wheel speed and acceleration sensing device according to one embodiment of the present disclosure. FIG. 5 is a view illustrating the state in which a wheel speed sensor and an acceleration sensor are disposed in the holder of the wheel speed and acceleration sensing device according to one embodiment of the present disclosure.

Referring to FIGS. 4 and 5, the holder 150 may include a first sensor seating part 151, a second sensor seating part 152, and a cable seating part 153. The wheel speed sensor 120 may be disposed in the first sensor seating part 151. An acceleration sensor 130 may be disposed in the second sensor seating part 152.

The first sensor seating part 151 may include a first sensor seating plate 151a supporting a lower surface of the wheel speed sensor 120 and a first sidewall 151b protruding upward from the first sensor seating plate 151a and surrounding at least a portion of a side surface of the wheel speed sensor 120.

In addition, the first sensor seating part 151 may further include a lead frame supporting wall 151c protruding upward between the plurality of lead frames 122 of the wheel speed sensor 120 and supporting the lead frames 122.

The second sensor seating part 152 may include a second sensor seating plate 152a supporting a lower surface of the acceleration sensor 130 and a second sidewall 152b protruding upward from the second sensor seating plate 152a and surrounding at least a portion of a side surface of the acceleration sensor 130.

In one embodiment of the present disclosure, the second sensor seating plate 152a of the second sensor seating part 152 may have a quadrangular shape. In addition, the second sidewall 152b may protrude upward from three edges of the second sensor seating plate 152a excluding a portion in contact with the cable seating part 153.

As described above, the acceleration sensor 130 may include the acceleration sensing element 131 and the circuit board 132. The acceleration sensing element 131 may be coupled onto the circuit board 132.

The circuit board 132 may have a quadrangular plate shape. In this regard, the second sensor seating plate 152a and the second sidewall 152b of the second sensor seating part 152 may define a quadrangular seating space, and the acceleration sensor 130 may be disposed in the quadrangular seating space.

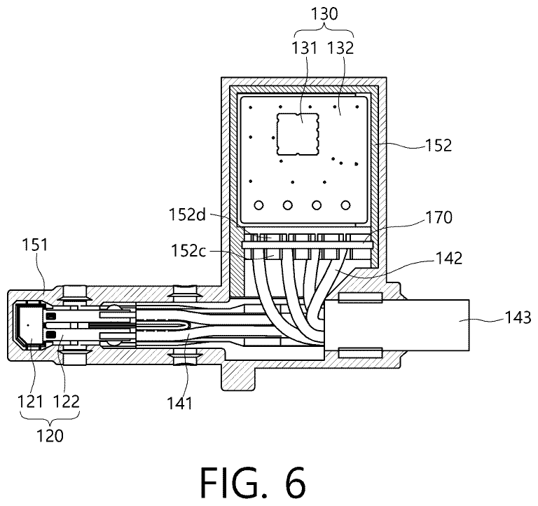

FIG. 6 is a view illustrating a state in which the wheel speed sensor and the acceleration sensor are disposed in the holder of the wheel speed and acceleration sensing device and the cables are connected to the wheel speed sensor and the acceleration sensor according to one embodiment of the present disclosure.

As illustrated in FIG. 6, the plurality of wheel speed sensor cables 141 or the plurality of acceleration sensor cables 142 electrically connected to the wheel speed sensor 120 or the acceleration sensor 130 may be disposed in the cable seating part 153.

More specifically, the cable seating part 153 may include a cable guide 153a, which extends toward one side of the first sensor seating part 151 and in which the plurality of wheel speed sensor cables 141 exposed from one end portion of the integrated sheath 143 and extending toward the wheel speed sensor 120 are disposed, and an integrated sheath seating groove 153b connected to one side of the cable guide 153a to surround at least a portion of an outer circumferential surface of the integrated sheath 143.

Meanwhile, referring to FIGS. 4 to 6, the second sensor seating part 152 may further include first guide walls 152c. The first guide walls 152c protrude upward from the second sensor seating plate 152a to be spaced a predetermined interval from each other at a portion, at which the plurality of acceleration sensor cables 142 electrically connected to the acceleration sensor 130 enter the acceleration sensor 130, and form a plurality of entry paths which guide the plurality of acceleration sensor cables 142 to enter in one direction.

In addition, the second sensor seating part 152 may further include second guide wall 152d. The second guide wall 152d protrudes upward from the second sensor seating plate 152a to be spaced a predetermined interval from each other at a portion spaced apart from the first guide walls 152c in one direction to extend the plurality of entry paths.

In this case, side portions of the quadrangular space in which the acceleration sensor 130 is disposed may be defined by the second sidewall 152b and the second guide wall 152d protruding upward from the second sensor seating plate 152a. That is, the acceleration sensor 130 may be disposed in the space surrounded by the second sidewall 152b and the second guide walls 152d.

In one embodiment of the present disclosure, the first sensor seating part 151 may be disposed in one end portion of the holder 150. In addition, the cable seating part 153 may extend toward one end of the first sensor seating part 151. In addition, the second sensor seating part 152 may be connected to a side portion of the cable seating part 153.

More specifically, the holder 150 may have an “L” shape. The first sensor seating part 151 and the second sensor seating part 152 may be disposed on end portions of the holder 150 having the “L” shape, and the cable seating part 153 may be disposed to connect the first sensor seating part 151 and the second sensor seating part 152.

Meanwhile, the holder 150 may be formed of a single member. In other words, the first sensor seating part 151, the second sensor seating part 152, and the cable seating part 153 may be integrally formed. For example, the first sensor seating part 151, the second sensor seating part 152, and the cable seating part 153 may be integrally manufactured through injection molding.

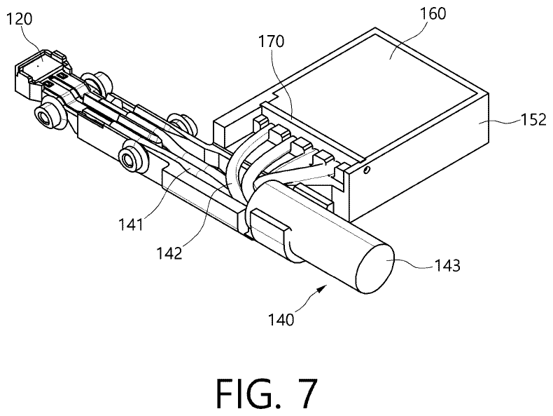

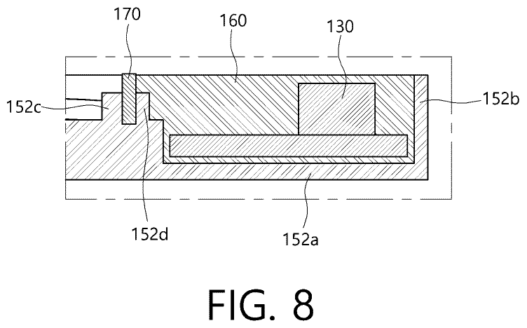

FIG. 7 is a view illustrating a state in which the wheel speed sensor and the acceleration sensor are disposed in the holder of the wheel speed and acceleration sensing device, the cables are connected to the wheel speed sensor and the acceleration sensor, and the second sensor seating part is filled with the filling member according to one embodiment of the present disclosure. In addition, FIG. 8 is a cross-sectional view illustrating the second sensor seating part in one direction in the state in which the wheel speed sensor and the acceleration sensor are disposed in the holder of the wheel speed and acceleration sensing device, the cables are connected to the wheel speed sensor and the acceleration sensor, and the second sensor seating part is filled with the filling member according to one embodiment of the present disclosure.

Referring to FIGS. 7 and 8, the filling member 160 is disposed to fill a space between the second sensor seating part 152 and the acceleration sensor 130 to fix the acceleration sensor 130 to the second sensor seating part 152. As the filling member 160 is disposed to fill the space between the second sensor seating part 152 and the acceleration sensor 130, the acceleration sensor 130 is stably fixed to the second sensor seating part 152.

As described above, the acceleration sensor 130 may include the circuit board 132, and a gap may be generated between the circuit board 132 and the second sensor seating plate 152a and the second sidewalls 152b of the second sensor seating part 152. In other words, the acceleration sensor 130 may not be stably fixed to the second sensor seating part 152 and may move.

The filling member 160 allows the acceleration sensor 130 to be stably fixed to the second sensor seating part 152 without movement. Accordingly, the acceleration sensor 130 may be stably fixed and correctly detect a vertical acceleration of the vehicle.

As described above, the housing 110 may be formed through injection molding in the state in which the wheel speed sensor 120, the acceleration sensor 130, and the integrated wire 140 are disposed in the holder 150. In this regard, the filling member 160 allows the acceleration sensor 130 to be stably fixed without being separated from the second sensor seating part 152 when the housing 110 is injection-molded.

In addition, the filling member 160 protects the acceleration sensor 130 from an external environment. Accordingly, the reliability of the acceleration sensor 130 can be improved.

The filling member 160 may be formed of a resin material. For example, the filling member 160 may be formed of an epoxy material.

In one embodiment of the present disclosure, the filling member 160 may be formed by curing a resin applied on a structure in which the wheel speed sensor 120 and the acceleration sensor 130 are disposed in the holder 150 and the wheel speed sensor cable 141 and the acceleration sensor cable 142 are connected to the wheel speed sensor 120 and the acceleration sensor 130, respectively.

The filling guide member 170 defines a boundary of one side of the filling member 160 and is disposed between the first guide wall 152c and the second guide wall 152d. A slot may be formed between the first guide wall 152c and the second guide wall 152d, and the filling guide member 170 may be inserted into the slot formed between the first guide wall 152c and the second guide wall 152d.

As described above, the filling member 160 may be formed by curing the resin applied on the structure in which the wheel speed sensor 120 and the acceleration sensor 130 are disposed in the holder 150 and the wheel speed sensor cable 141 and the acceleration sensor cable 142 are connected to the wheel speed sensor 120 and the acceleration sensor 130, respectively.

In addition, since the filling member 160 is for fixing the acceleration sensor 130 to the second sensor seating part 152, the filling member 160 does not need to be applied on the outside of a region in which the acceleration sensor 130 is disposed. In this regard, the filling guide member 170 prevents the filling member 160 from being unnecessarily excessively formed outside the second sensor seating part 152.

Referring to FIGS. 3 and 7, the filling guide member 170 may include a guide body 171 and a plurality of grooves 172.

The guide body 171 supports the filling member 160 and prevents diffusion of the filling member 160. The guide body 171 may be formed in a quadrangular plate shape. In addition, the guide body 171 may be inserted into the slot formed by the first guide walls 152c and the second guide walls 152d.

The grooves 172 may be formed to be recessed upward from a lower corner of the guide body 171 to be spaced a predetermined interval from each other such that the plurality of acceleration sensor cables 142 disposed in the plurality of entry paths are inserted into the grooves 172.

As the acceleration sensor cables 142 are inserted into the plurality of grooves 172, respectively, the acceleration sensor cables 142 may be fixed. In other words, the filling guide member 170 may define the boundary of one side of the filling member 160 and also serve to fix the acceleration sensor cable 142.

As the plurality of acceleration sensor cables 142 are fixed by the filling guide member 170, the connection between the acceleration sensor 130 and the acceleration sensor cable 142 can be stably maintained.

The wheel speed and acceleration sensing device 100 according to one embodiment of the present disclosure has been described above in detail. Hereinafter, a method S100 of manufacturing a wheel speed and acceleration sensing device for manufacturing the wheel speed and acceleration sensing device 100 according to one embodiment of the present disclosure will be described.

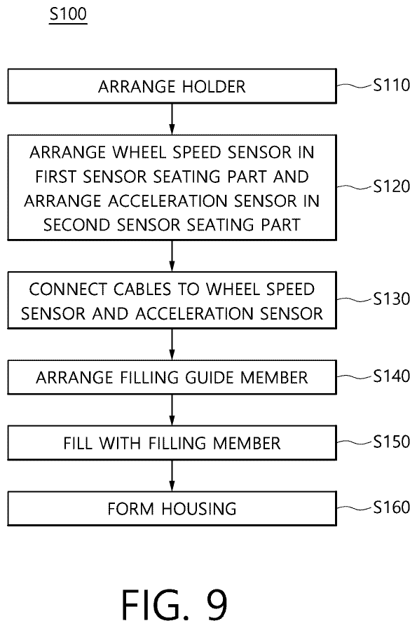

FIG. 9 is a flowchart illustrating a method of manufacturing a wheel speed and acceleration sensing device according to one embodiment of the present disclosure.

The method S100 of manufacturing a wheel speed and acceleration sensing device according to one embodiment of the present disclosure may be performed to manufacture the wheel speed and acceleration sensing device 100 according to one embodiment of the present disclosure.

Referring to FIG. 9, the method S100 of manufacturing a wheel speed and acceleration sensing device according to one embodiment of the present disclosure may be performed as follows.

First, the holder 150 is disposed (S110).

In this case, the holder 150 may include the first sensor seating part 151 and the second sensor seating part 152. In addition, the holder 150 may further include the cable seating part 153. The cable seating part 153 may be disposed to connect the first sensor seating part 151 and the second sensor seating part 152.

The holder 150 may be formed by performing integrally injection molding on the first sensor seating part 151 and the second sensor seating part 152. More specifically, the holder 150 may be formed by performing integrally injection molding on the first sensor seating part 151, the second sensor seating part 152, and the cable seating part 153.

Then, the wheel speed sensor 120 is disposed in the first sensor seating part 151, and the acceleration sensor 130 is disposed in the second sensor seating part 152 (S120).

In one embodiment of the present disclosure, the wheel speed sensor 120 may have an IC chip type and include the wheel speed sensor body 121 and the lead frames 122 extending toward one side of the wheel speed sensor body 121.

As described above, the first sensor seating part 151 may include the first sensor seating plate 151a supporting the lower surface of the wheel speed sensor 120 and the first sidewall 151b protruding upward from the first sensor seating plate 151a and surrounding at least a portion of the side surface of the wheel speed sensor 120.

The wheel speed sensor body 121 of the wheel speed sensor 120 may be seated in the seating space defined by the first sensor seating plate 151a and the first sidewall 151b.

In addition, in the first sensor seating part 151, the plurality of lead frames 122 may be supported by the lead frame supporting wall 151c protruding upward from between the plurality of lead frames 122 of the wheel speed sensor 120.

In one embodiment of the present disclosure, the acceleration sensor 130 may include the acceleration sensing element 131 and the circuit board 132 on which the acceleration sensing element 131 is disposed. In this case, the circuit board 132 may have the quadrangular plate shape.

Meanwhile, the second sensor seating part 152 may include the second sensor seating plate 152a supporting the lower surface of the acceleration sensor 130 and the second sidewall 152b protruding upward from the second sensor seating plate 152a and surrounding at least a portion of the side surface of the acceleration sensor 130.

In addition, the second sensor seating part 152 may further include the first guide walls 152c and the second guide walls 153d in addition to the second sensor seating plate 152a and the second sidewall 152b. Each of the first guide walls 152c and the second guide walls 153d protrude upward from the second sensor seating plate 152a to be spaced a predetermined interval from each other at the portion, at which the plurality of acceleration sensor cables 142 electrically connected to the acceleration sensor 130 enter the acceleration sensor 130, and form the plurality of entry paths which guide the plurality of acceleration sensor cables 142 to enter in one direction.

In this case, the second guide walls 152d may be disposed at a portion spaced apart from the first guide walls 152c in one direction to protrude upward from the second sensor seating plate 152a to be spaced a predetermined interval from each other. In addition, the quadrangular space in which the acceleration sensor 130 is disposed may be defined by the second sidewall 152b and the second guide walls 152d protruding upward from the second sensor seating plate 152a. In other words, the acceleration sensor 130 may be disposed in the space surrounded by the second sidewall 152b and the second guide walls 152d.

Then, the plurality of cables are connected to the wheel speed sensor 120 and the acceleration sensor 130 (S130).

More specifically, the plurality of wheel speed sensor cables 141 may be connected to the wheel speed sensor 120. In this case, one of the plurality of wheel speed sensor cables 141 may be for connection with the power source, and the other may be for transmitting or receiving a signal.

In addition, the plurality of acceleration sensor cables 142 may be connected to the acceleration sensor 130. In this case, one of the plurality of acceleration sensor cables 142 may be for connection with the power source, and the other may be for transmitting or receiving a signal.

Then, the filling guide member 170 which defines the boundary of one side of the filling member 160 is disposed in the second sensor seating part 152 (S140).

As described above, the filling member 160 fills the space between the second sensor seating part 152 and the acceleration sensor 130 and serves to fix the acceleration sensor 130. Accordingly, the filling member 160 is sufficient to fill the space in which the acceleration sensor 130 is disposed.

In this regard, the filling guide member 170 may be disposed to define the boundary of one side of the filling member 160. In other words, the filling guide member 170 may prevent the filling member 160 from being diffused outward from the second sensor seating part 152 outside the filling guide member 170.

Meanwhile, a boundary of the remaining side portion of the filling member 160 may be defined by the second sidewall 152b. In addition, a boundary of a lower side of the filling member 160 may be defined by the second sensor seating plate 152a.

Specifically, the filling guide member 170 may define the boundary of one side of the filling member 160 and may be disposed between the first guide wall 152c and the second guide wall 152d. A slot perpendicular to an entry direction of the acceleration sensor cable 142 is formed between the first guide walls 152c and the second guide walls 152d, and the filling guide member 170 may be inserted into the slot formed between the first guide walls 152c and the second guide walls 152d.

Meanwhile, the filling guide member 170 may include the guide body 171 having the plate shape and the plurality of grooves 172 formed to be recessed upward from the lower corner of the guide body 171. Accordingly, the filling guide member 170 may define the boundary of one side of the filling member 160 and serve to fix the plurality of acceleration sensor cables 142 as well.

Then, the filling member 160 fills the space between the second sensor seating part 152 and the acceleration sensor 130 (S150).

As the filling member 160 fills the space between the second sensor seating part 152 and the acceleration sensor 130, the acceleration sensor 130 may be fixed to the second sensor seating part 152. More specifically, the filling member 160 may be applied into the space between the second sensor seating part 152 and the acceleration sensor 130 and then cured.

The filling member 160 may be disposed to fill an empty space between the acceleration sensor 130 and the second sensor seating part 152 in a space defined by the second sensor seating plate 152a, the second sidewall 152b, and the filling guide member 170.

In this case, the filling member 160 may be formed of a resin material. For example, the filling member 160 may be formed of an epoxy material.

Finally, the housing 110 which covers the holder 150, the wheel speed sensor 120, and the acceleration sensor 130 is formed (S160).

The housing 110 may be disposed to cover a portion of the integrated wire 140 disposed in the holder 150, the filling member 160, and the filling guide member 170 in addition to the holder 150, the wheel speed sensor 120, and the acceleration sensor 130.

The holder 150, the wheel speed sensor 120, the acceleration sensor 130, the portion of the integrated wire 140 disposed in the holder 150, the filling member 160, and the filling guide member 170 may be disposed in the housing 110. More specifically, the housing 110 may be disposed to seal the holder 150, the wheel speed sensor 120, the acceleration sensor 130, the portion of the integrated wire 140 disposed in the holder 150, the filling member 160, and the filling guide member 170 from the outside.

For example, the housing 110 may be injection-molded. In this case, since the wheel speed sensor 120 is fixed to the first sensor seating part 151 of the holder 150 and the acceleration sensor 130 is fixed by the filling member 160 in the second sensor seating part 152 when the housing 110 is injection-molded, locations thereof can be maintained even when an injection pressure is applied.

A wheel speed and acceleration sensing device and a method of manufacturing the same according to one aspect of the present disclosure are directed to simplifying a layout of a wheel side of a vehicle through the housing in which a wheel speed sensor and an acceleration sensor are integrally mounted and improving assemblability of the vehicle.

A wheel speed and acceleration sensing device and a method of manufacturing the same according to one aspect of the present disclosure are directed to improving sensing accuracy of wheel speed and acceleration and durability using a holder and a filling member which allow the wheel speed sensor and the acceleration sensor to be stably fixed in one housing.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification.

Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A wheel speed and acceleration sensing device comprising:
a housing;
a wheel speed sensor which is disposed in the housing and detects the wheel speed of the vehicle; and
an acceleration sensor which is disposed in the housing and detects the vertical acceleration of the vehicle.

2. The wheel speed and acceleration sensing device of claim 1, further comprising:
a plurality of wheel speed sensor cables each having one end portion connected to the wheel speed sensor in the housing and the other end portion extending outward from the housing;
a plurality of acceleration sensor cables each having one end portion connected to the acceleration sensor in the housing and the other end portion extending outward from the housing; and
an integrated sheath which covers the plurality of the wheel speed sensor cables and the plurality of the acceleration sensor cables extending outward from the housing in one bundle.

3. The wheel speed and acceleration sensing device of claim 2, wherein the integrated wire further includes a connector connected to the other end portion of each of the plurality of the wheel speed sensor cables and the plurality of the acceleration sensor cables such that the plurality of the wheel speed sensor cables and the plurality of the acceleration sensor cables are connected to an outside.

4. The wheel speed and acceleration sensing device of claim 1, further comprising a holder disposed in the housing and including a first sensor seating part in which the wheel speed sensor is disposed and a second sensor seating part in which the acceleration sensor is disposed.

5. The wheel speed and acceleration sensing device of claim 4, wherein the holder further includes a cable seating part which extends toward one side of the first sensor seating part and in which the plurality of wheel speed sensor cables or the plurality of acceleration sensor cables electrically connected to the wheel speed sensor or the acceleration sensor are disposed.

6. The wheel speed and acceleration sensing device of claim 5, wherein the second sensor seating part of the holder is connected to a side portion of the cable seating part.

7. The wheel speed and acceleration sensing device of claim 4, wherein the first sensor seating part includes:
a first sensor seating plate supporting a lower surface of the wheel speed sensor; and
a first sidewall protruding upward from the first sensor seating plate and surrounding at least a portion of a side surface of the wheel speed sensor.

8. The wheel speed and acceleration sensing device of claim 4, wherein the second sensor seating part includes:
a second sensor seating plate supporting a lower surface of the acceleration sensor; and
a second sidewall protruding upward from the second sensor seating plate and surrounding at least a portion of a side surface of the acceleration sensor.

9. The wheel speed and acceleration sensing device of claim 8, further comprising a filling member disposed to fill a space between the second sensor seating part and the acceleration sensor to fix the acceleration sensor to the second sensor seating part.

10. The wheel speed and acceleration sensing device of claim 9, wherein the filling member is formed of a resin material.

11. The wheel speed and acceleration sensing device of claim 9, wherein the second sensor seating part further includes first guide walls which protrude upward from the second sensor seating plate to be spaced apart from each other at a portion, at which the plurality of acceleration sensor cables electrically connected to the acceleration sensor enter the acceleration sensor, and form a plurality of entry paths which guide the plurality of acceleration sensor cables to enter in one direction.

12. The wheel speed and acceleration sensing device of claim 11, wherein the second sensor seating part further includes second guide walls which protrude upward from the second sensor seating plate to be spaced apart from each other at a portion spaced apart from the first guide walls in one direction to extend the plurality of entry paths.

13. The wheel speed and acceleration sensing device of claim 12, further comprising a filling guide member which defines a boundary of one side of the filling member and disposed between the first guide walls and the second guide walls.

14. The wheel speed and acceleration sensing device of claim 13, wherein the filling guide member includes:
a guide body supporting the filling member and preventing diffusion of the filling member; and
a plurality of grooves recessed upward from a lower corner of the guide body to be spaced apart from each other such that the plurality of acceleration sensor cables disposed in the plurality of the entry paths are inserted into the plurality of grooves.

15. The wheel speed and acceleration sensing device of claim 9, wherein the housing is disposed to seal the holder, the wheel speed sensor, the acceleration sensor, and the filling member from an outside.

16. A method of manufacturing a wheel speed and acceleration sensing device, comprising:
arranging a holder including a first sensor seating part and a second sensor seating part;
arranging a wheel speed sensor in the first sensor seating part and arranging an acceleration sensor in the second sensor seating part;
connecting a plurality of cables to each of the wheel speed sensor and the acceleration sensor; and
forming a housing which covers the holder, the wheel speed sensor, and the acceleration sensor.

17. The method of claim 16, wherein the holder is formed by performing integrally injection molding on the first sensor seating part and the second sensor seating part.

18. The method of claim 16, further comprising filling, with a filling member, a space between the second sensor seating part and the acceleration sensor to fix the acceleration sensor to the second sensor seating part between the connecting of the plurality of cables and the forming of the housing.

19. The method of claim 18, further comprising arranging a filling guide member which defines a boundary of one side of the filling member in the second sensor seating part before the filling with the filling member.

20. The method of claim 16, wherein the housing is injection-molded in the forming of the housing.
